(19) United States
(12) Patent Application Publication
(10) Pub. No.: US 2014/0130056 A1
(43) Pub. Date: May 8, 2014

(54) Parallel Execution Framework

(71) Applicant: Rational Systems LLC, Houston, TX (US)

(72) Inventor: Nicholas Mark Goodman, San Mateo, CA (US)

(73) Assignee: Rational Systems LLC, Houston, TX (US)

(21) Appl. No.: 14/071,642

(22) Filed: Nov. 4, 2013

Related U.S. Application Data
(60) Provisional application No. 61/722,606, filed on Nov. 5, 2012.
(60) Provisional application No. 61/722,585, filed on Nov. 5, 2012.
(60) Provisional application No. 61/722,615, filed on Nov. 5, 2012.

(51) Int. Cl. G06F 9/50

(52) U.S. Cl. CPC G06F 9/5038
USPC 718/104

(57) ABSTRACT

An improved method for dividing and distributing the work of an arbitrary algorithm, having a predetermined stopping condition, for processing by multiple computer systems. A scheduler computer system accesses a representation of a plurality of work units, structured as a directed graph of dependent tasks, then transforms that graph into a weighted graph in which the weights indicate a preferred path or order of traversal of the graph, in turn indicating a preferred order for work units to be executed to reduce the impact of inter-work unit dependencies. The scheduler computer system then assigns work units to one or more worker computer systems, taking into account the preferred order.

This application claims the benefit of the following commonly-owned co-pending provisional applications: Ser. No. 61/722,585, “Offloading of CPU Execution”; Ser. No. 61/722,606, “Parallel Execution Framework”; and Ser. No. 61/722,615, “Lattice Computing”; with the inventor of each being Nicholas M. Goodman, and all filed Nov. 5, 2012. All of these provisional applications are incorporated by reference, in their entirety, into this application.

This application is one of three commonly-owned non-provisional applications being filed simultaneously, each claiming the benefit of the above-referenced provisional applications, with the inventor of each being Nicholas M. Goodman. The specification and drawings of each of the other two non-provisional applications are incorporated by reference into this specification,

### 1. BACKGROUND OF THE INVENTION

### The Need to Process Large Quantities of Measurement Data

This invention relates to an improved method for performing large numbers of computations involving a great deal of data. Such computations are required in numerous modern business scenarios. For example, many people will be familiar with the meter reader making her monthly trek through people's yards; getting chased by the occasional dog; and—most importantly for our purposes—writing down meter-reading numbers in a ledger or other record, which would be used later to produce monthly utility bills. That was certainly the case some years ago; in many locations today it still the state-of-the-art. The future, however, is smart meters, digital readings, wireless measurement, and near-real-time computation of up-to-the-minute billing information. Systems incorporating some of these capabilities are envisioned, and even online already, in various places in the United States and Europe.

The increasing use of such smart meters, and the broader category of smart measurement, are not merely a hallmark of the internet age; they also represent a major challenge to software. Much existing business software is designed to handle a small set of semi-static data, not a huge volume of data. Think back to the meter reader and her manual readings. A traditional monthly electricity bill is constructed by multiplying the difference in meter readings from month to month, times the monthly rate for electricity (or gas or water). Even at its most complex, this system required dividing the change in measurement from the prior reading by the number of days, then summing the products of the daily prorated measurements multiplied by the relevant daily rates.

In a Big-Data future, as the measurement of physical systems becomes more granular, applications must process much, much more data. The one electricity measurement per month has become one measurement per fifteen minutes, and the monthly rate has become the instantaneous market price of electricity on a so-called liquid exchange. Thus, the one multiplication (measurement times rate) has become at least 30×24×60/4(=10,800) multiplications per home per month. This may well overwhelm many existing software applications.

By changing their approach to the processing of data, software companies can deal with this change in the volume of data. Instead of approaching problems as a whole, they can break problems into their component parts and send the components to processing centers. Many computational problems can be broken into components that could be executed anywhere. This last part “could be executed anywhere” is important because technology has advanced to the point where CPU cycles are almost a commodity. They are not yet, but this mechanism attempts to move closer to achieving commoditized CPU power.

### Barriers in High-Performance Computing

In high-performance scientific computing for academic and government purposes, parallel processing of work by large numbers of high-end computers provides well-known advantages of speed and throughput. A disadvantage here, though, is that the development of specific algorithms for parallel processing of particular problems can take decades and involve dozens if not hundreds of highly-educated computer scientists and mathematicians. Papers are published and Ph.D dissertations based on incremental improvements to existing algorithms.

Moreover, the execution of such algorithms can entail the use of costly, high-performance computer systems comprising hundreds or even thousands of computers. For example, one could purchase a small 1000-node cluster (a node is a computer), each with two graphics cards with eight graphics processing units (GPUs). Then one could use the CUDA programming language and develop a parallel library to execute the required floating point operations. That is, of course, if one had a million dollars sitting around and six months to devote to learning CUDA and writing code.

The above disadvantages are seen especially in many areas of business computing. In those areas, algorithms to address particular problems need to be developed quickly, in months or even days. These algorithms typically are worked on by small teams of competent but not necessarily cutting-edge programmers, who generally work on computer systems containing far fewer computers that might be seen in an academic- or government setting.

Moreover, because of this dramatic difference in computational environments (as well as what might be thought of as “cultural differences”), workers who develop high-performance parallel processing algorithms in academia and government tend not to be concerned with—and thus not to address—problems in business computation, and vice versa.

The foregoing means that for all intents and purposes, high-performance computing in the academic- and government arenas on the one hand, and in the business arena on the other, might as well be different fields of art. As a result, the benefits of high-performance parallel processing often are not as readily available in the business context as they might be in academia or the government.

### 2. SUMMARY OF THE INVENTION

When a computational task has a predetermined stopping condition, it can be broken down into separate subtasks, and the subtasks distributed to different processors or computer systems for action. In that situation, some or even all of the subtasks can often be completed in parallel, thus reducing the time needed for the overall task to be completed. I describe here an improved method (with several variations) for dividing and distributing the work of arbitrary algorithms having predetermined stopping conditions for parallel processing by multiple computer systems. A scheduler computer system accesses a representation of a plurality of work units, structured as a directed graph of dependent tasks, then transforms that graph into a weighted graph in which the weights indicate a preferred path or order of traversal of the graph. That path represents a preferred order for work units to be executed to reduce the impact of inter-work unit dependencies. The scheduler computer system then assigns work units to one or more worker computer systems, following the preferred order where possible and not undesirable for other reasons (for example, due to failure or where duplication of effort is desirable).

### 3. BRIEF DESCRIPTION OF THE DRAWINGS

FIG. 1 is a simplified diagram of a scheduler 100 connected to one or more worker computer systems 102 in accordance with the invention.

FIGS. 2 through 5 are graphs depicting structured representations of work units.

FIGS. 6 and 7 illustrate an example discussed in the text.

FIGS. 8 through 13 are reproductions of drawings mentioned in papers by the inventor that were included in the above-cited provisional application; those papers are reproduced in part 5 of this specification and so the mentioned drawings are included for completeness.

### 4. DETAILED DESCRIPTION OF SPECIFIC EMBODIMENTS

### Computer Systems Overview

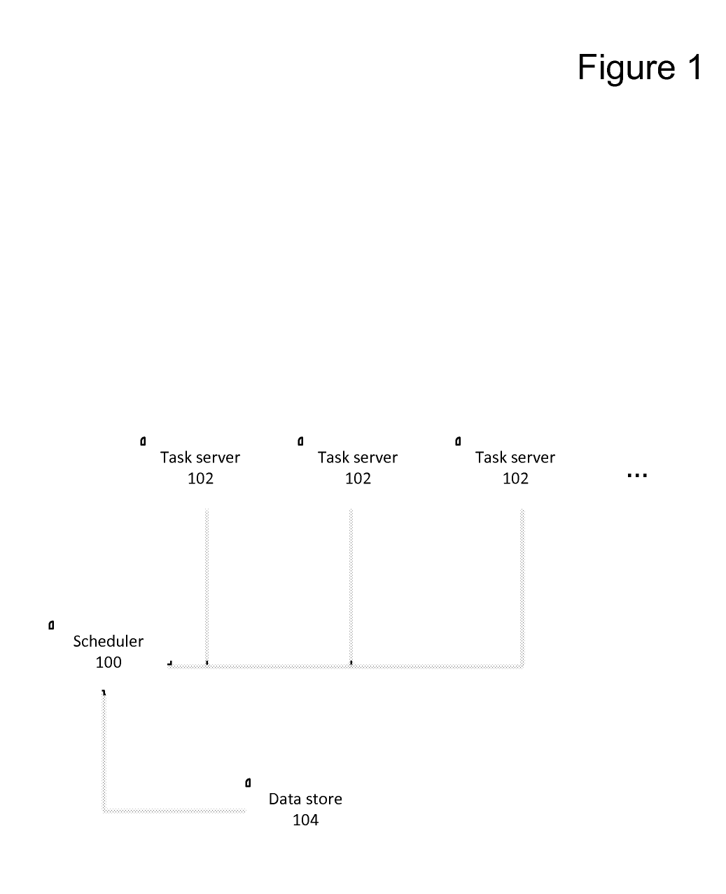

Referring to FIG. 1, a scheduler computer system in accordance with the invention, referred to as a scheduler 100, communicates with one or more worker computer systems, each referred to as a task server 102. The hardware and basic operating software of the scheduler 100 and the task servers 102 are conventional; any or all could take the form of, for example a Windows, Macintosh, Unix, or GNU/Linux machine, possibly rack-mounted. One or more of such machines could include single- or, more likely, multiple-core central processing units (CPUs). One or more such machines could also be implemented by renting computing capacity on a suitable “cloud” system such as the well-known Amazon Web Services (AWS).

The machines may variously reside in the same physical location and be connected via one or more conventional Ethernet networks, or they may reside in multiple locations and be connected via a conventional wide-area network or via a conventional Internet connection. Other connection possibilities will of course be apparent to those of ordinary skill having the benefit of this disclosure.

In some implementations, it might be desirable to implement one or more of the scheduler 100 and the various task servers 102 as multiple, or even many, machines, for example in a conventional clustered- or parallel architecture. A distributed architecture, with different machines in different physical locations, might also be desired for increased robustness, reliability, processing power, redundancy, and so forth.

The various software controlling the scheduler 100 and the task servers 102 might treat any one of their CPUs and/or cores, or some combination thereof, as a separate computer using any of a variety of well-known multi-threading approaches.

For purposes of illustration, a method in accordance with the invention is executed by a scheduler 100 that operates in conjunction with a plurality of task servers 102, which advantageously may be in different physical locations. To those of ordinary skill having the benefit of this disclosure, it will be apparent that the scheduler 100 may also serve as a task server 102. Likewise, each task server 102 may have multiple CPUs and/or multiple CPU cores.

API: Each task server 102 executes a respective software program (referred to here as a “task server”) that can cause the task server to perform one or more types of computational tasks (referred to here generically as “work”) when assigned by the scheduler 100. Each such task server includes (or operates in conjunction with) code for providing one or more application program interfaces (“APIs”), each conventionally designed (and perhaps adapted from pre-existing APIs) for the particular application need, to manage communications between the task server 102 and the scheduler 100. Any two task servers 102 might provide the same type of task server and the same type API, or they might provide different types of task server, API, or both. (Alternatively, the API could be equivalently provided by interface software such as so-called “middleware.”)

The tasks to be executed by the various task servers 102 can be more or less arbitrary, subject of course to relevant constraints of the particular computer, operating system, etc. Consequently, various task-server software can be written for various task servers 102 to perform bits and pieces of virtually any computational work that can be broken into smaller tasks.

### Inputting Tasks and Dividing them into Work Units

As mentioned in the Summary of the Invention, the method described below relates to algorithms that have predetermined stopping conditions. Definitions of the specific work to be done in executing (that is, performing) the algorithm in question are inputted as one or more component units of work, sometimes referred to as “work units,” that eventually will be executed by various task servers 102. Importantly, a given work unit could stand alone computationally, or it could depend upon the output of prior work units and/or upon initial cached values; an approach for addressing this is discussed in more detail below.

Here is a simple illustrative example: Suppose that a power company needs to produce bills for each of its 100,000 customers. Suppose also that each customer has at least one “smart” meter, and—significantly—that some business customers have multiple meters. The power company might input a definition of the algorithm, that is, the computational work, of generating customers' monthly power bills in terms of summing the products of each relevant customer's power usage for a given period times the spot (market) rate for power at the relevant time, where power usage is computed by subtracting a previous meter reading from the then-current meter reading. For example, Total Billed Amount=Billed Amount for Meter 1+Billed Amount for Meter 2+ . . . , where Billed Amount for Meter 1=(Spot Rate 1×(Meter 1 Reading 1−Meter 1 Reading 0))+(Spot Rate 2×(Meter 1 Reading 2−Meter 1 Reading 1))+ . . . . Each of these component calculations might constitute a work unit as a part of the larger work of calculating the Total Billed Amount. The algorithm has a predetermined stopping condition, namely that the execution of the algorithm ceases when all of the component calculations have been done and the Total Billing Amount has been computed. It will be apparent that the computation of the Total Billed Amount for a given customer is dependent on the computation of the individual meters' Billed Amount numbers.

(Those skilled in the art will recognize that the work units can be defined or described in one or more convenient manners, such as, for example, direct SQL queries; pseudo-SQL queries that identify concepts but hide the details; and pre-built code units, either built or bought.)

These definitions of specific work units can be input in any convenient manner using the server 100 or another computer system. For example, such definitions may be conventionally displayed on a monitor as they are being input by a user using a keyboard, mouse, or other input device, for example as a series of rows in a table; likewise, pre-stored definitions could be retrieved and edited in essentially the same manner. The user could also define a series of weights to be multiplied by the functions. In one experimental implementation, I used a conventional Web form, implemented with a Java Servlet and an ActionScript front-end, to provide a user input mechanism to enter work units; those of ordinary skill having the benefit of this disclosure will be quite familiar with such Web forms and so they will not be discussed further here. In another experimental implementation, program code, executed by the scheduler 100, divided a natural gas pipeline allocation balancing task into work units from a set of queries executed against a database storing natural gas pipeline data.

The work units so inputted are stored in a structured representation in a convenient data store 104. That structured representation may be created and managed by the scheduler 100 itself; by another computer (not shown); or some combination of the two.

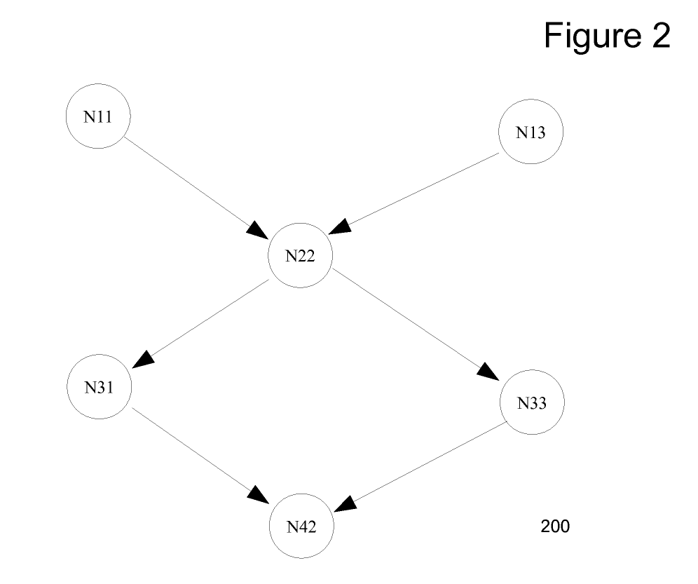

FIG. 2 shows a visual depiction of a simple structured representation of this type. Each work unit is represented by a node N11, N13, etc., in a graph 200 that in some ways resembles a lattice. Those skilled in the art will recognize that in this context, the term “graph” refers to a collection of “nodes” linked by “edges,” which can be either directed (typically depicted pictorially as one-way arrow lines) or undirected (non-arrow lines). In FIG. 2, the arrow lines represent dependencies; for example, work unit N22 depends on work unit N11 and N13, perhaps (for example) because the computation of work unit N22 makes use of results from the other two computations.

The various units of work represented in the graph 200 may be of similar size and scope, but they do not need to be.

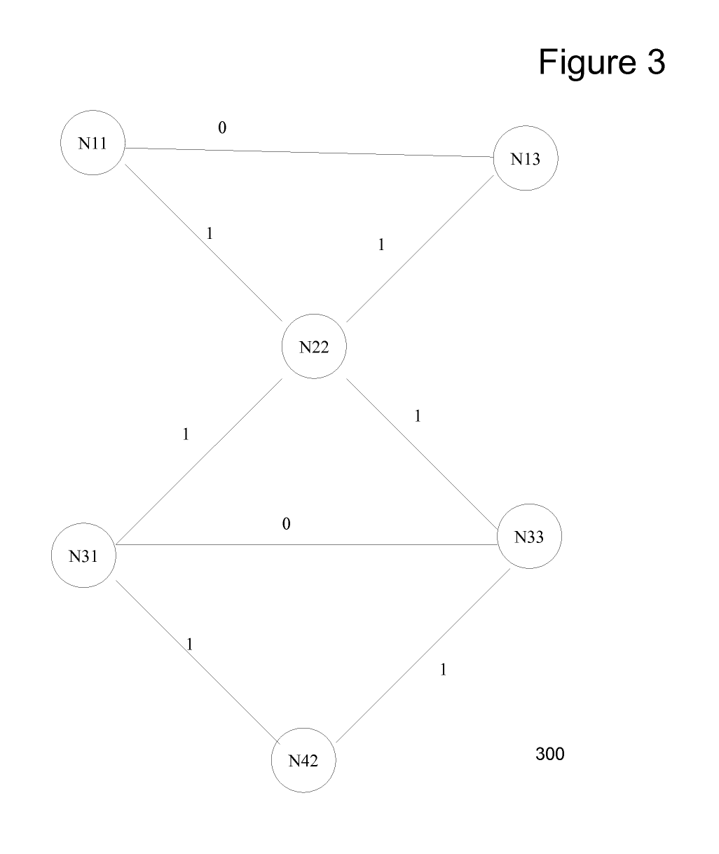

Referring to FIG. 3: The graph 300 is an enhancement of the graph 200, in that in the graph 300, each link between various nodes N11, etc., in the graph 200 is assigned a weight number, either one or zero, to represent the cost of computing the ending node after computing the starting node. A cost weighted as zero means that dependencies in the direction of that link are not a concern; a cost weighted as one means the opposite. For example, in FIG. 3 the link between nodes N11 and N13 is weighted at zero (because the two associated work units are not dependent on each other), while the link between nodes N11 and N22 is weighted as one. This reflects one way of looking at many business problems in which the total problem can be broken into a lattice-like structure of subproblems in which each row in the lattice depends upon prior rows and is loosely connected to other subproblems in the same row. (It will be apparent to one of ordinary skill having the benefit of this disclosure that the structured representation could be a directed or undirected graph, or any structure that defined a relationship between units of work.) Applying the same logic as before, the disjoint (separated) nodes in graph 200 are shown in graph 300 as being connected by zero-weight links, again showing an absence of dependencies between the links.

It is worth noting that there are many possible ways of building graphs of the type shown. Similarly, the sparse nature of horizontal links in this structure should indicate that the work may be divided easily in most cases. In fact, if there are no horizontal links, this becomes an “embarrassingly parallel” problem.

### Determining the Shortest Path of Work Execution

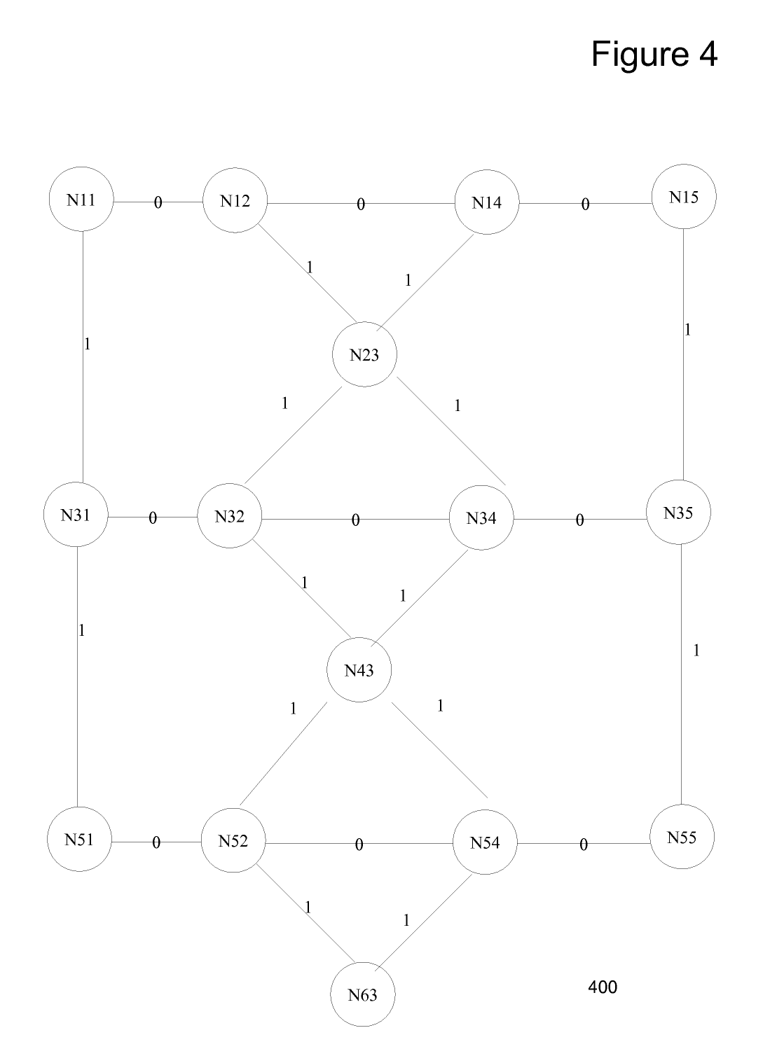

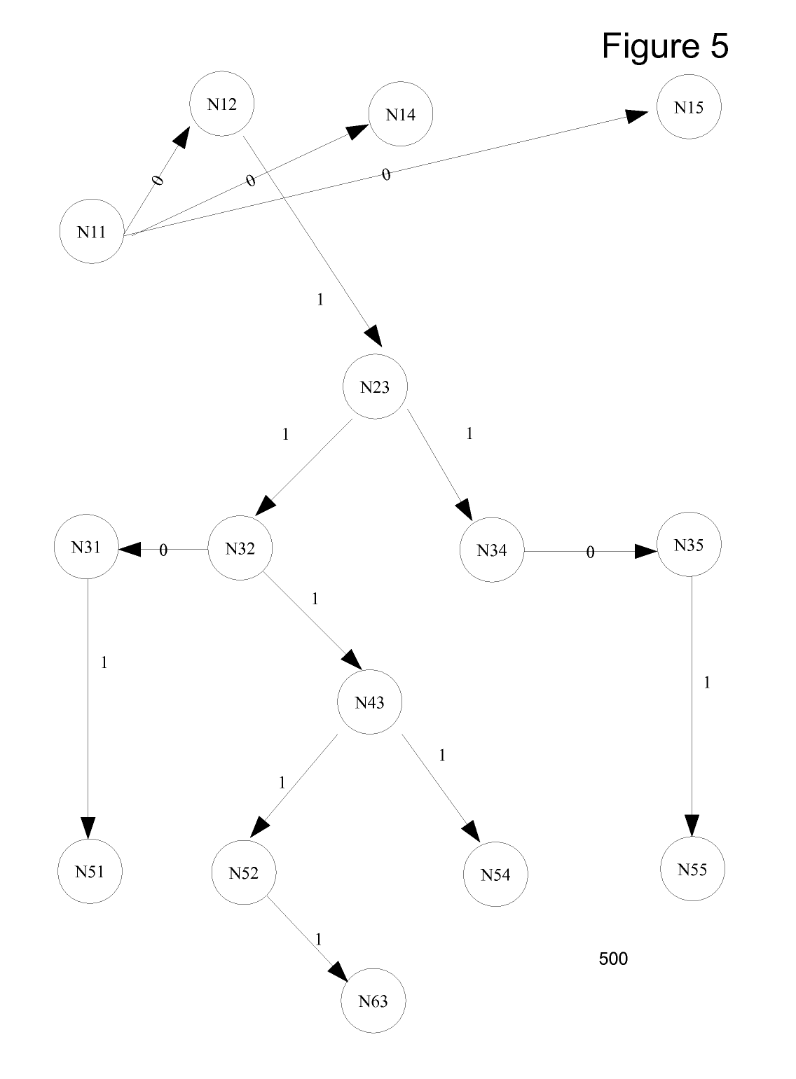

Referring now to FIG. 4: A more-complex example of a weighted-link work unit graph is shown in graph 400 (which is unrelated to graphs 200 and 300). A preferred order of executing the work units shown as nodes in graph 400 is represented by the shortest paths through the graph. Those shortest paths pass through the artificial, zero-weight links before traversing the one-weight links that represent existing dependencies. This is shown in FIG. 5, in which the graph 500 shows the shortest paths that traverse the graph 400.

Those of ordinary skill having the benefit of this disclosure will recognize that the arrows in the graph structure indicate that a pathing algorithm or a spanning tree algorithm are likely to be effective techniques at determining a preferred path through the graph.

### Assignment of Work Units to Task Servers

The scheduler 100 accesses the structured representation stored in the data store 104, referred to here for convenience as simply the graph 500. The scheduler 100 sends, to each of various task servers 102, instructions for performing an allocated set of one or more of the work units represented in the graph 500. The scheduler 100 may transmit the work units via a conventional mechanism such as TCP/IP using the HTTP or HTTPS protocol. In one embodiment the initial set of work contains multiple units of work.

### Task-Server Processing of Work Units

Each task server 102 receives and processes any work-unit instructions sent to it. Typically, as part of its API mechanism the task server 102 runs a conventional client executor module that maintains a portal (much like an in-box) to which the scheduler 100 can post work units (or pointers to work units) to be carried out by the task server 102. The task server can then do its own internal scheduling of the work-unit instructions it receives. Both the portal technique and the internal scheduling technique will be familiar to those of ordinary skill having the benefit of this disclosure.

The task server 102 eventually terminates its processing of the work-unit instructions. Termination can be either successful completion of the work unit or some non-success event such as a failure or even a “sorry, can't do this right now” rejection of the work unit. The task server 102 informs the scheduler 100 of the termination: via the API, the task server transmits to the scheduler a signal identifying the relevant unit of work and the type of termination, plus optionally any computational results to be returned. The transmission is typically done via HTTP or HTTPS over a TCP/IP connection.

The scheduler 100 updates the graph 500 (as stored in the structured representation in the data store 104) to indicate the status of the work unit. It takes into account any non-success report from the task server 102 and redirects work to the same task server, or to another task server 102 if necessary. Selecting another task server is a conventional task that can be done in any convenient manner, for example based on which task servers already had access to relevant data in memory.

The scheduler 100 may then send a next set of one or more work units to the task server 102. The scheduler 100 might have the next set of work units already “teed up” (for example, in a queue identifying an order of specific tasks to be performed) to send to the task server 102, or it might determine the next set of work units on a just-in-time basis. This determination of the next set of work units could be based, for example, upon the speed at which the particular task server 102 finished the prior work units, and/or on an assigned priority of the next work units, so that a set of lower-priority work units might be sent to a task server 102 that had previously demonstrated that it took a relatively-long time to finish prior work units.

It will be apparent to those of ordinary skill having the benefit of this disclosure that the scheduler 100 can also act as a task server 102 by running task-server program code of its own.

It will likewise be apparent that the task servers 102 can reside in more than one physical location.

### Caching, with Shared-Cache Variation

The various task servers 102 preferably interact with a cache to reduce the need for recomputation and the attendant extra work. This caching may be largely conventional but can be important for improving performance; the additional information provided below in Part 5 of this specification contains additional background details. The caching may be locationally-aware. The cache may optionally be a distributed cache. The caching may allow both push and pull techniques, configurable by data type.

In one experimental implementation, each task server 102 updated a database system (not shown) with the results of the processed work, with the updates then conventionally replicated to the cache. The task server 102 may also update the cache itself with its work results. Upon an update, insert, or deletion, the cache may transmit the updated or created objects to some or all other task servers 102, or transmit object identifiers of updated or created objects to some or all other task servers 102.

In another embodiment, a cache is shared by one or more of the task servers 102. Before retrieving, from a data store, data needed for a unit of work, each worker node checks its cache for that data. If the data exists in the cache, then the task server 102 continues. If the data does not exist in the cache, then the worker node retrieves the data from the data store and places it into the cache. Upon completion of a component or an entire of a unit of work, a worker node updates the cache with the results. If the cache is configured to be shared among more than one computer and if the data inserted into the cache is configured to be shared among more than one computer, then the cache sends either (i) an identifier of the data, or (ii) the data to the other task server 102 caches that are configured as connected.

Upon termination of the work unit, the task server 102 so informs the scheduler 100. The scheduler 100 updates the structured representation to indicate the status of the work unit.

### Natural-Gas Example

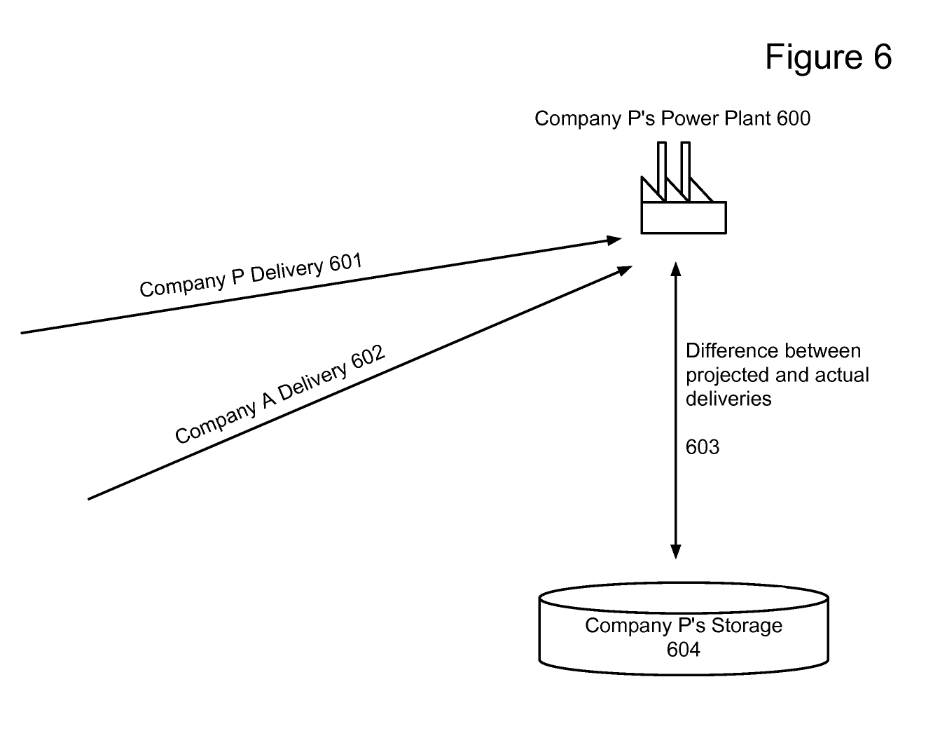

A specific industrial application relates to a computer-enabled method to balance the actual versus projected natural gas transportation across one or more natural gas pipelines. Referring to FIG. 6: Company P runs a natural gas power plant 600, which is fueled by gas delivered to it by Company P and by another company/shipper, Company A. The Company P delivery 601 and the Company A delivery 602 make up the delivered gas at the power plant 600 for a given day.

A transportation imbalance may exist on one or more pipelines between the actually-allocated deliveries and/or receipts versus the scheduled, or projected, deliveries and/or receipts. This can occur when the projected volume (scheduled volume) at a physical location is different from the actual volume (allocated volume) at the physical location. Because of the physical constraints on natural gas pipelines, these imbalances must be moved into or out of storage.

Thus, the transportation imbalance for Company P is determined by comparing the actual deliveries versus projected deliveries at the power plant 600 for both Company P's deliveries 601 and Company A's deliveries 602. The resulting imbalance 603 must be resolved by moving the equivalent amount of gas into or out of Company P's storage 604. This should occur independently of any balancing done for Company A (though the resolutions are related since Company A's transportation contracts are involved).

As a greatly-simplified example to set the stage, suppose that the management of the power plant 100 makes arrangements with its natural-gas pipeline system operator, under which the power plant 100, on a specific flow date, will receive, FROM the pipeline system, 2,000 dekatherms (DTH) of natural gas. (Such arrangements are known colloquially as “nominations.”) The pipeline system must be kept full of natural gas; therefore, the pipeline-system operator requires that such arrangements must designate one or more replenishment sources of natural gas to be delivered TO the pipeline system to replace the 2,000 DTH that the power plant 100 will receive FROM the pipeline system.

Toward that end, the power plant 600, by prior arrangement with Company P and Company S, advises the pipeline system company that the pipeline will receive corresponding deliveries of, say, 1,000 DTH “from” Company P and another 1,000 DTH “from” Company S. (In reality, the deliveries “from” the two companies would likely be from elsewhere, but by prior arrangement would be designated as being on behalf of the respective companies.)

It would not be uncommon for, say, Company P's replenishment delivery or deliveries TO the pipeline system to add up to only 800 DTH of its designated 1,000 DTH; this would be a shortfall of 200 DTH. That means that the pipeline system's operators might cause the pipeline system to deliver only a total of 1,800 DTH to the power plant 600, so that the pipeline would remain full; alternatively, the pipeline system's operator might cause the full 2,000 DTH to be delivered to the power plant 600 from the pipeline, but then the operator might require the power plant to make arrangements to promptly replace the shortfall from another source. (In reality, all of this is done through high-volume bookkeeping.)

In either case, the 200 DTH shortfall must come from somewhere. That “somewhere” might well be a storage tank such as Company P's storage tank 604.

As an additional wrinkle, it is common to assume that, say, 1% of the natural gas will be lost in the transaction due to the natural gas required to drive the compressors that move natural gas through the pipeline. In that case, the 200 DTH to be replaced in the pipeline would be increased to 202 DTH.

Now that this background has been established: In the illustrative method, a computer (which may be the scheduler 100) computes the transportation imbalances on one or more pipelines. That computer then creates a graph data structure representing the imbalances. Each node in the graph represents a single shipper on a single day. Each link in the graph is a direct dependency between nodes.

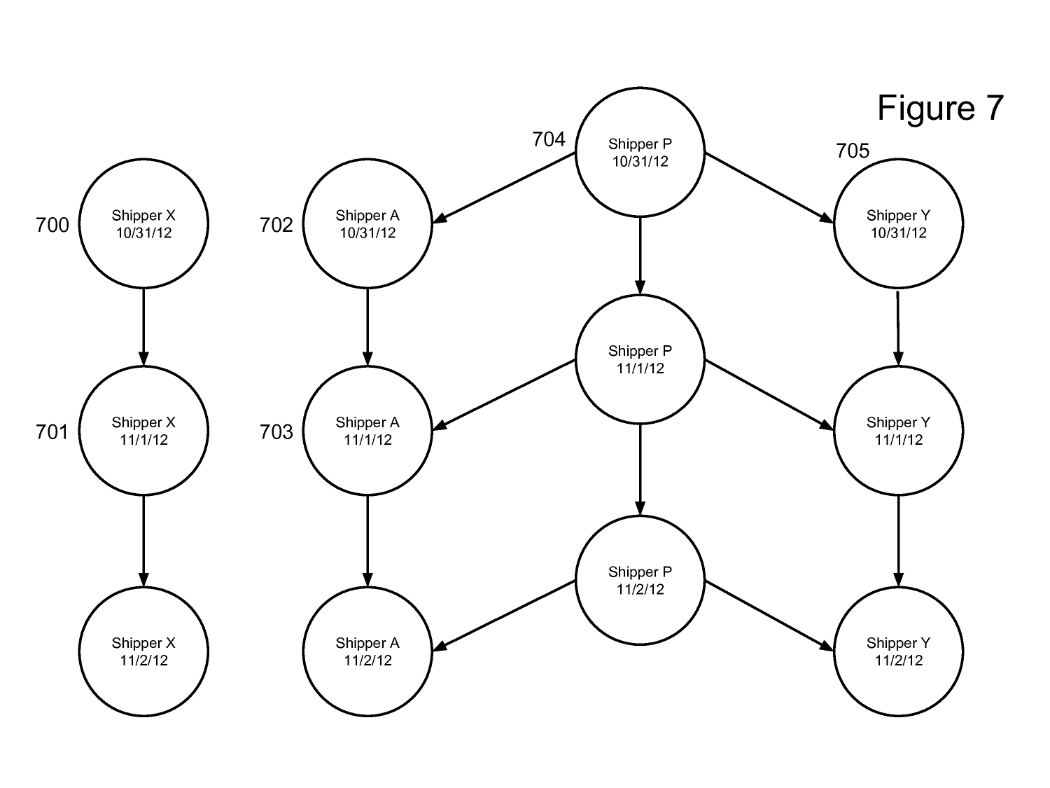

FIG. 7 shows another simplified example. The node 700 represents the resolution of Shipper X's transportation imbalance on 10/31/12, and node 701 represents the resolution of Shipper X's transportation imbalance on 11/1/12. The link from node 700 to node 701 indicates that Shipper X's resolution on 11/1 is dependent upon Shipper X's resolution on 10/31, or, reversing the wording, Shipper X's 10/31 resolution influences Shipper X's 11/1 resolution.

It is worth noting that the dependencies represented by the graph (see FIG. 7) are not necessarily physical dependencies. They are the business-level dependencies instead. For example, for natural gas pipelines, injections into and withdrawals from storage are often billed based upon the total percentage of the storage field in use by the shipper. It is often cheaper to inject when the balance is low and more expensive to inject when the balance is high (the reverse applies for withdrawals. Consequently, the day-over-day dependency is important in aggregate because, over lengthy span of time, it is likely that the storage charge thresholds are crossed. From one day to the next, however, there may be no impact (thus leading to the weights on the links discussed elsewhere in this specification).

In the situation of the power plant example, the node 702 represents Shipper A's resolution on 10/31. Node 704, shipper P's resolution on 10/31/12, influences the resolution represented by node 702. Note that the node 705 also depends upon node 704.

The balancing process creates a “least-cost” resolution that takes into account the transportation rates, transportation fuel, storage rates, storage fuel, overrun costs, and penalty costs. Consequently, the balancing process must resolve related imbalances together.

In our example, this means that the balancing process must resolve Company A's imbalance at the plant 600 along with Company P's imbalance at the plant 600 (and anywhere else that Company P has an imbalance). It must resolve Company A's other imbalances separately.

The balancing system must balance the resolution for Company P first because the imbalance from Company A's delivery 602 goes into or out of Company P's storage on Company P's contracts. If Company A's resolution was computed first, then the imbalance from Company A's delivery 602 would go into or out of Company A's storage instead (contrary to the agreement between companies A and P).

Thus, the dependency between nodes 704 and 702 is related to the way in which the auto balancing business process is implemented.

Continuing with the description of this method: The scheduler 100 accesses the work representation 104 and allocates initial sets of work to one or more task servers 102. Each task server 102 computes a least-cost transfer of natural gas in or out of storage for each the shipper it is working on. The least-cost transfer is based upon prior-day storage balances and current-day transportation volume, and preferably takes into account any expressed user preferences (which can be retrieved from a profile stored in a data store or accepted as input from a user). It also preferably takes into account the cost of transportation, fuel loss, and the cost of storage. Each task server 102 issues commands that cause the respective shippers' storage balances to update accordingly. Upon completion of a single shipper's balance for a single day, a task server 102 requests that the scheduler transmit one or more shipper-days to compute.

The above process is repeated as long as work remains to be done.

### Programming; Program Storage Device

The system and method described may be implemented by programming suitable general-purpose computers to function as the various server- and client machines shown in the drawing figures and described above. The programming may be accomplished through the use of one or more program storage devices readable by the relevant computer, either locally or remotely, where each program storage device encodes all or a portion of a program of instructions executable by the computer for performing the operations described above. The specific programming is conventional and can be readily implemented by those of ordinary skill having the benefit of this disclosure. A program storage device may take the form of, e.g., a hard disk drive, a flash drive, another network server (possibly accessible via Internet download), or other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here.

### Alternatives

The above description of specific embodiments is not intended to limit the claims below. Those of ordinary skill having the benefit of this disclosure will recognize that modifications and variations are possible; for example, some of the specific actions described above might be capable of being performed in a different order.

### 5. ADDITIONAL INFORMATION

The following information was filed as part of the above-referenced provisional patent applications. It is included in this specification in case it is deemed “essential information” and thus not able to be incorporated by reference. Certain spelling errors have been corrected; drawings in the original have been moved to the drawing figures; and some reformatting has been done to conform more closely to U.S. Patent and Trademark Office guidelines.

### Near Real-Time Parallel Execution Framework: Nick Goodman, Spring 2012

Section 1: Core Framework. Section 2: Test Implementation Description: Auto Balancing. Section 3: Shared Context Transfer Agent. Section 4: Application Programmer Interface (API) [NOT INCLUDED IN PROVISIONAL FILING NOR HERE]. Section ?: Extension 1: Framework Used to Process Dependency Changes in Real-Time. Section ?: Test Implementation Results: Auto Balancing.

### Section 1: A Framework for the Parallel Execution of Business Logic

### Section 1.1 Motivation

Business software development is often focused primarily on creating effective software and taking it to market quickly. The perfect solution is often ignored due to the cost of implementation of the perceived complexity of implementation. Even though a parallel solution to a difficult problem may be desirable, it is often ignored. The framework addresses this problem by removing the complexity of parallel execution and allowing the business developer to quickly parallelize large problems.

### Section 1.2 General Approach

In computational sciences and engineering, one generally attempts to parallelize an existing algorithm or equation. These equations and algorithms are often well-understood and are reused across domains. Business software, however, often uses unique algorithms that are studied only by the implementing organization. Thus, the economy of scale that generally exists in having many computational scientists looking at the algorithm simply do not exist.

Rather than attempting to parallelize an existing algorithm and achieve optimal performance, this framework instead has the developer break the work into atomic units and describe a dependency lattice (which solutions depend upon other solutions). An atomic unit of execution is one that, if all other variables are fixed, can be correctly in finite time.

Once the units of execution and the dependency lattice are defined, the framework is capable of parallelizing the execution. This framework does not directly handle inter-process communication (this does not preclude processes from communicating via some other mechanism).

### Section 1.3 the Dependency Lattice

### Section 1.3.1: Dependency Lattice Overview

A dependency lattice describes the relationship between units of execution and their inputs. These inputs may be other units of execution or may be independent data. A vertex in the dependency lattice represents the probability that a change to the source node causes a change to the destination node. In many cases, this probability will be one or zero (for visualization purposes zero-weight vertices are hidden).

A lattice is sparse when the majority of its vertices are of zero-weight. Any dependency lattice that contains no loops must, therefore, be sparse. Sparseness is of great value in scheduling. In many business cases, there will be many disjoint sub lattices, which are connected to other lattices only by zero-weight verticies. Such sub lattices are also valuable when scheduling.

The application developer describes his/her algorithm in terms of the dependency lattice. The nodes are units of execution, which the developer will write, and the vertices are dependencies, which the scheduler will manage. The developer must create one of three mechanisms for the executor to run: a Java class than can be executed, a RMI call, or a web service. The Java execution wrapper must implement the AutomicExecutionUnit, which extends java.util.Runnable, interface and it must be instantiatable from any of the execution nodes (this may require adding a jar file of the class to the execution application servers). The RMI method must take in the node id as an input. The web service must take in the node id as a HTTP parameter. In all three of these mechanisms, the executable unit must be able to determine the work it must do from a node's unique identifier.

### Section 1.3.2 Pathing a Simple Dependency Lattice

Given the following basic dependency lattice, where the arrows points in the direction of direct dependency (lack of an arrow indicates no dependency), we can create artificial nodes and weight each edge. [SEE FIG. 2]

Artificially weight edges that go horizontally 0 and edges that exist 1. [SEE FIG. 3]

Clearly, the shortest path through this lattice utilizes the artificial, 0-weight links before using the existing dependencies. This creates the desired path through the lattice.

### Section 1.3.3: Pathing Disjoint Dependency Lattices

Apply the same logic as before, connecting the disjoint lattices with 0-weight horizontal lines. [SEE FIG. 4]

An Example Shortest Path [SEE FIG. 5]

### Section 1.4 Scheduling

The scheduler component of the framework determines the optimal order in which to run atomic units of execution. It does this by applying machine learning to the probabilities in the dependency lattice. The nodes in the dependency lattice represent an atomic unit of execution, and the vertices in the dependency lattice represent the probability that a change to the source node requires a recomputation of the destination node. Given the probabilities and knowledge of which nodes require recomputation, the scheduling algorithm determines the path of execution that requires the least overall computation (fastest execution and least likely to require recomputation). The scheduler sends the work to the execution queues (the scheduler knows how many queues are available and how many threads each queue has at its disposal). This machine-learning approach is beneficial when the atomic units of work are of unequal complexity because it will learn how to adjust the schedule appropriately.

Alternatively, one can setup the scheduler to use the simplest approach and wait for notification that the prior thread has completed its execution. This is advantageous when the workload is unknown or is unpredictable.

The scheduler is only capable of computing an optimal execution plan for uni-directional dependency lattices.

### Section 1.5 Execution

The framework runs within a Java 2 Enterprise Edition (J2EE) application server. It uses the Java Messaging Service (JMS) API to spawn worker threads, It can be accessed either directly via a Remote Method Invocation (RMI) call or via a web service (useful when one wants to have non-Java invocation). Separating the execution context and the scheduling context like this allows one to write one's own scheduler in any language and to extend the framework's core functionality. Both the RMI and web service interfaces return either success or failure statuses to the caller. This status only reflects the success or failure to spawn a worker thread (not the status of the executing code). Optionally, the caller can specify a callback method that will be notified when the thread terminates.

### Section 1.? Process Flow

Each node in the dependency lattice has a unique identifier
A service (JMS queue, web service, or database table) stores a record for each node that requires a recomputation
Any process updating any record related to the business process, notifies the service
Alternatively, if you want to recompute on a fixed interval (of time), the notifications can be ignored and all verticies will have a time-based or fixed probability
The re-computation process kicks off: 1) at a fixed time or 2) when a threshold of work is reached

### Section 1.? Lazy Dependencies

When a solution S1 depends upon a portion of the solution S0, it may be that even if S0 changes, S1 may not change. Thus, when this occurs, computing S0 and S1 in parallel is potentially (due to scheduling) more efficient that computing S0 and then S1. Moreover, if the execution environment has idle CPUs, it may be more efficient to compute S1 in the hope that it will not need to be recomputed. If one did this and every Si needed to be recomputed, the overall solution would be no slower than a serial computation of each Si. If any Si did not need to be recomputed, however, having computed in parallel each Si has potentially saved many CPU cycles. For example, if one computes S0 through S1000 in parallel and it S500 needs to be recomputed, then the speed up is still 50% (because S1-S499 do not need to be recomputed). Moreover, it is even possible that only S500 needs to be recomputed (and not S501-S1000), which is a 99.9% speed improvement (if one had enough CPUs) compared to the serial execution of the code.

### Section 2: Auto Balancing, a Test Implementation

### Section 2.1: General Description of Auto Balancing

Auto Balancing settles to storage the difference between scheduled and allocated natural gas flows on the Columbia Gas Transmission Corporation (TCO) pipeline. The smallest unit of balancing is the auto balancing relationship (henceforth relationship) on a single flow day (natural gas is generally scheduled and allocated daily).

### Section 2.2: Auto Balancing Dependencies

### Nominations

Natural gas transporters place nominations on the interstate natural gas pipelines through which their gas will flow. Nominations are the underlying unit of flow on such pipelines (a nomination represents physical flow on a pipeline). Most nominations are placed before flow (so that they can be scheduled), but they can be made after flow (generally when one party forgot to place a nomination).

### Scheduling

Scheduling is the process by which physical flow on a natural gas pipeline are coordinated (between the pipeline itself, upstream and downstream pipelines, and the nominating customers). Scheduling ensures the physical integrity of the pipeline, guarantees deliveries to residential customers (this is mandated by federal law), and enforces the contractual rights and obligations of the entities nominating on the pipeline. Gas pipelines in the United States schedule a day's natural gas flow in four cycles: On-Time (ONT), Evening (EVE), Intra-Day 1 (ID1), and Intra-Day 2 (ID2). The ONT and EVE cycles are scheduled before gas flows (they are sometimes called timely for this reason); whereas, the ID1 and ID2 cycles are scheduled during the day that gas flows (so they cannot effect the quantity that flowed before them). The scheduled quantities of a nomination change to reflect the physical and commercial constraints on the pipeline and its customers. While not all nominations are changed through the scheduling process, all nominations are scheduled. Once the Intra-Day 2 cycle is scheduled, every nomination on the pipeline is considered to be scheduled. This final scheduled quantity, which represents the best available prediction for the gas that will flow, is used by auto balancing.

### Measurement

Natural gas flow is measured by physical devices attached to various locations on the pipeline. These points may are generally a connection to a Local Distribution Company (LDC), power plant, industrial user, or another pipeline (though other pipelines are not generally covered by auto balancing). Some measurement is tracked on an hourly or 15-minutely basis; whereas, other measurement (primarily residential consumption) is measured monthly or bi-monthly. Moreover, many measurements are entered by hand into a measurement-tracking system, so human error in reading occurs. Thus, measurement may change months after flow.

### Allocation

While measurement tracks the gas that actually flows, allocation is the process of apportioning the measured gas to the various parties who nominated gas at a point. A physical point is controlled by one or more entities (corporations or public-utilities); thus, the controlling entity is responsible for making up the difference between the gas that was scheduled and allocated (called the imbalance) at its points. In some cases, more than one entity controls a point. This is common with power plants and industrial users; in such cases, the gas is allocated to the controlling parties based upon an allocation scheme). Since allocation depends upon measurement, it can change many times in the months after flow. Moreover, since allocation schemes represent the business arrangements between various parties, they change (even after the fact).

### Storage Balances

Natural gas is generally stored underground in depleted natural gas deposits. The ability to inject or withdrawal gas from storage is (physically) dependent upon the amount of gas already in storage. Additionally, natural gas generally cannot be injected into full storage and cannot be withdrawn from empty storage fields. Additionally, commercial constraints limit storage access. Natural gas is a seasonal industry; demand generally go up in the winter (when it is cold and natural gas is burned in people's homes) and in the summer (when it is hot and natural gas is used in power plants for air conditioning load). Additionally, the demand for gas in winter is so great that the pipelines (which generally bring gas from the south to the north) are filled to capacity. Thus, pipelines often have commercial rules limiting injections in the winter and limiting withdrawals in the summer.

This is not to say that gas cannot be injected in the winter or withdrawn in the summer, just that one pays a penalty if one withdraws beyond the limit in the winter or injects beyond the limit in the summer. These limits are based upon the percentage of gas the customer holds in the ground (generally there are limits that change at 10%, 20% and 30% of capacity utilization). Because auto balancing injects and withdraws gas to resolve a transportation imbalance, it depends upon the storage balance at the beginning of each flow date (because auto balancing is designed to be a “least-cost” solution, so it avoids penalties when possible).

All of this is equivalent to saying that auto balancing depends, to a degree, on prior days' auto balancing resolutions. This dependency is realized when the storage balance shifts from one ratchet to another (if the ratchet does not change, then the prior days are irrelevant to the current day's solution).

### Contracts

Natural gas pipelines contract space to commercial entities on a long term basis; however, the contracted capacity can be “released” (selling it temporarily to another shipper) and “recalled” (exercising a contractual option to take back released capacity). Thus, the contractual rights are potentially different for any given day. Since auto balancing uses contractual capacity (both transport and storage), it depends upon these changes.

### Other Relationships

An auto balancing relationship describes how contracts will be balanced. Some relationships require that other relationships be completed first. This occurs because many shippers must be balanced, according to the tariffs filed with the Federal Energy Regulatory Commission (FERC). Thus, the custom relationships covering a contract must be resolved before the default relationships are resolved.

### Section 2.3: Implementation Phases

I have implemented the auto balancing process in two phases to demonstrate the flexiblity of the framework: 1. relationship partitioning 2. relationship and flow-date partitioning

Auto balancing generally balances several months' worth of data. For the first phase of the test implementation, I created a dependency lattice by relationship but not by relationship and flow date.

Thus, each node in the dependency lattice represents several months of balancing for a single relationship. The dependencies between nodes, therefore, are relatively limited.

For the second phase of the test implementation, I created a dependency lattice by relationship and flow date. Thus, the dependency lattice is much more complicated, though it represents the same inputs and outputs.

### Section 2.4: Expected Performance Improvements

Since the dependency lattice is extremely sparse, the dependencies should not slow down the execution of the various threads (because threads will not have to wait for data). Thus, the process should be strongly scalable (the number of threads is inversely proportional to the execution time). The current process preloads all of the pertinent data before beginning execution. If this is still done and the data is communicated to each node, then the remaining work should scale.

### Section 3: Shared Context Transfer Agent

### Section 3.1: Motivation

When a process executes one a single machine, the developer may choose to keep results in memory (or on local disk) to allow for later use. In a multi-node environment, local memory is unavailable to other nodes. Thus, results that need to be reused must be explicitly shared with other nodes. The Shared Context Transfer Agent (SCTA) hides the complexity of caching and data transfer behind a Java API and web service.

### Section 3.2: Description

Shared data may take any form. The SCTA requires that the data be serializable and be identifiable. The former is achieved via the java.io.Serializable interface. The developer provides the latter in the form of an alpha-numeric key.

When a node has a result that may be needed by another node, it sends a message to the Cache Controller (CC). The message includes the unique id of the data object, the object itself, and the local cache id of the object. If the object is new, the cache id is 0; otherwise, it is the cache id from the local Cache Interface (CI). The CC compares the cache id of the updated object with that of the CC's local cache id. If the new id is not higher than the CC's local cache id, the update is rejected, and the node recieves a failure message. If the update is accepted, the CC sends and acceptance message that includes the new cache id.

The SCTA environment distributes data changes in two ways: Actively Pushed (AP) and Passively Pulled (PP). AP data is sent, upon receipt by the CC, to each CI. The CI then updates its local memory. The CC sends the updated cache id to each CI when in PP mode. Then, if the CI needs access to the updated data, it requests that data from the CC. The AP mode reduces waits by worker nodes; whereas, the PP mode reduces overall data transfer at the cost of responsiveness. The modes can be combined by initially transferring an initial set of data to each CI and then moving into PP mode. The data transfer mode is configurable by node.

### Section 3.3: Cache Interface (CI)

The CI resides on each worker node. It uses static memory to store data. When it is updated by a local process, the update is pushed into an outbound JMS queue. The queue spawns a local thread to send the data to the CC. The thread processes the entire transfer (including rolling back the local change if needed; this can be set by a policy); it terminates when the transfer is complete. A web service responds to inbound updates; it directly updates the local static memory and responds to the sender when complete. Throughout these processes, data access is synchronized to allow for transaction-like updates to the SCTA (it only commits if all updates succeed).

The CC and CI could be extended to use a database when larger datasets are needed.

### Section 3.4 Cache Controller (CC)

The CC is an independent Java application that runs within a J2EE application server. It uses either local memory or a database to store cache updates.

### Section 3.5 Objects

The SCTA system can share six primitive data types—integer, float, double, long, string, and binary—and two complex data types—lists and maps. A list contains zero or more data objects (of one or more data types, including complex data types). A map contains zero or more key-value pairs; the key is a string, and the value is any of the data types. The CC and CI use (potentially zipped) JavaScript Object Notation (JSON) to communicate. The system does so because the protocol is simple and effective for the data types being shared and because it makes the system interoperable with other systems (including non-Java ones). The use of these technologies does not effect the data that the user stores as long as the objects being stored are serializable (implement java.io.Serializable). The CC does not need to be able to deserialize binary objects; it simply treats them as their byte representation and leaves the serialization and deserialization to each CI.

### Section 4 not Included in Provisional Filing

### Section 5: Small Group Scheduling

### Section 5.1: Motivation

### Section 5.2: Description

Split the work such that each piece may be governed by three nodes (not threads). The three nodes are responsible for their work and are responsible for its integrity. Thus, instead of the traditional master-slave computational relationship, the three nodes work together to complete their work. Each of the three nodes holds a copy of the work (though in a striping scheme, only two would need the data). The nodes track which node is working on the data. In order for a node to work on the data, it my inform the other two nodes in its committee. When one of these nodes responds affirmatively that the work may proceed, then the node begins. Each node marks which node is working on a task. In the event that all nodes are online, this process adds a small amount of communications overhead (compared to the master-slave scenario). However, by limiting the communication to a small group (1 to 2 and 2 to 1), it removes the communications bottleneck at the master node. Additionally, the three node system works like database mirroring technology: a quorum of two nodes is required to determine what is the “valid” configuration. If a single node goes down, the other two nodes can still continue, and the single node should recognize that it is disconnected (and perhaps it can take some corrective measures).

This system may be inter-leaved so that a single node is connected to multiple work queues. If the three-node setup is maintained, then a hexagonal lattice occurs. This structure is useful if a node is lost because the node represents one sixth of the processing power for the six queues upon which it acts. Moreover, the lattice may self-correct for the loss of multiple nodes by repositioning the lattice. Alternatively, one can think of this lattice as a triangulation (mesh) of the computational domain.

When a node is lost from the domain, the mesh may be maintained by adding edges. Doing so maintains the value of the quorum, the built-in redundancy, and the parallel efficiency.

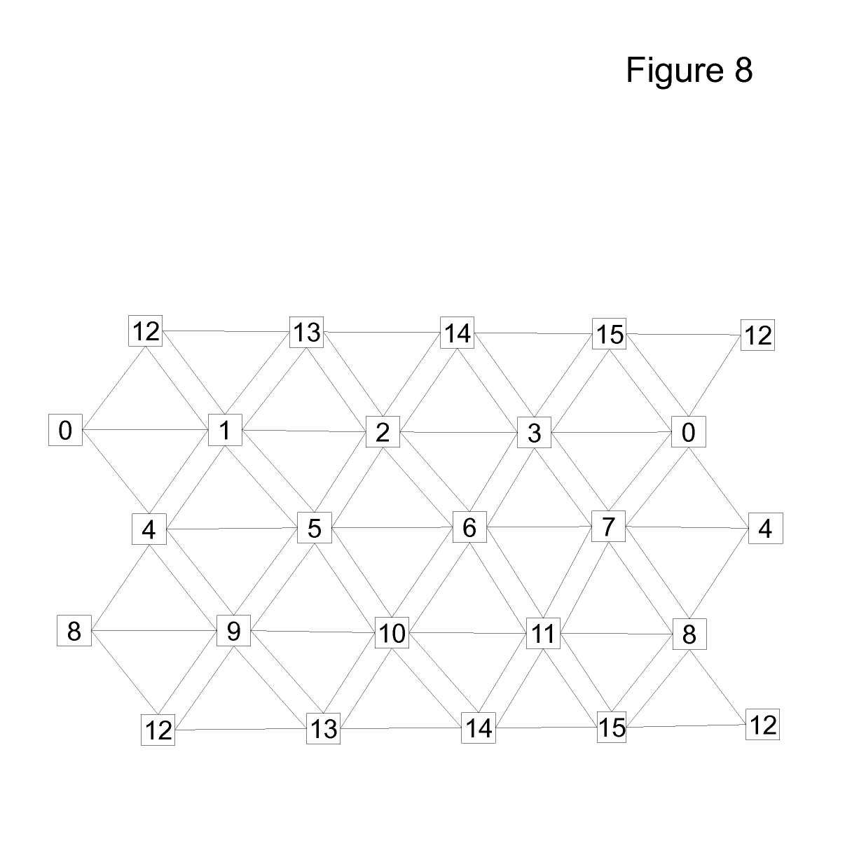

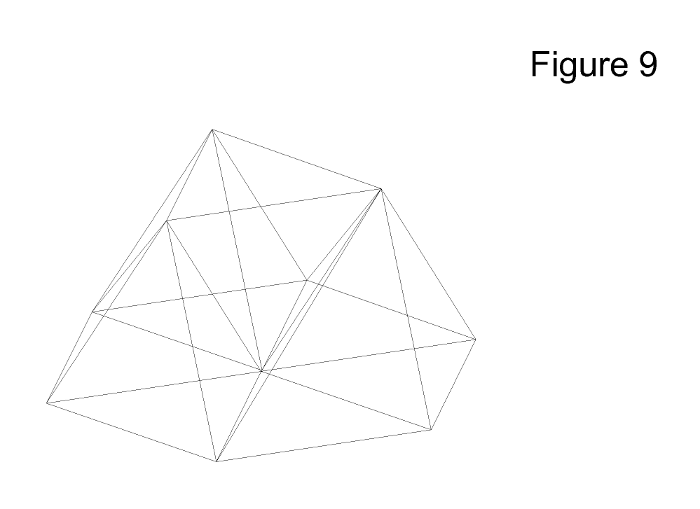

When made multidimensional, this structure can be load balancing as well. If there are exactly as many work queues as triangles in a one-dimensional triangulation of the nodes, then there is no room for heterogeneous computing power or workloads. Instead of creating a single master node to divide work, as in the master-slave relationship, create a set of master nodes to be triangulated into master committees. Create a triangulation of the master nodes. Each triangulation of master nodes can be load balanced so that the power of the triangulation is maintained. These nodes, like their lower-level counterparts, must follow the quorum (2 nodes are needed to make a decision about splitting work). If the top-level nodes are under-utilized, they can start working on the computational work they have to give away (since they control it, they simply do not give it out to child nodes). [SEE FIG. 8]

### PROBLEMS/QUESTIONS TO RESOLVE

1. How do I store the dependencies in a problem-independent manner?

2. What about interdependent problems (like scheduling); a impacts b, b impacts a

3. In auto balancing, a large portion of the time is spent loading the data.•We could split the data into time-dependent and time-independent data and broadcast the time-independent data

4. Can I put a probability on the likelihood of change that decreases as the date gets farther into the past? A probability model would allow me to decide priorities on the nodes in the dependency lattice. Perhaps this would allow me to perform network simplex (the cost of each vertex is the probability that the change in the starting vertex will impact the ending vertex). This would produce and “optimal” ordering of the processing (and when combined with the re-run checker, would be very powerful).•This problem could be visualized as a lattice of nodes; red nodes would need work done and green nodes would be fine; yellow nodes may need work (depending on the red nodes).•The use could change a node's color or the weight of a vertex•As the process is running, it can recompute the network simplex solution based upon the updated inputs•A vertex that requires recomputation could be an (negative) infinitely weighted path

5. Can MemCached be used instead of the SCTA?

### A Case Study in Parallelizing Business Applications

### Independent Study Report, University of Colorado Computer Science, May 2012

### Nick Goodman

### Introduction

This paper details my investigation into the use of parallel processing to improve a business process within an enterprise-level, transaction-processing system for the natural gas industry. I chose the auto balancing process (within the Rational Pipe application) because I was involved in its design from the beginning and understand the complexities and subtleties of both the technical and business processes. This investigation was not an attempt to achieve a tangible improvement to the process itself, though I hope that my work may be useful for the application; rather, I view auto balancing as a microcosm of business computing. It is an excellent test case for several reasons:
Auto balancing was designed by a business user with some technical experience
It was designed with NO intention of running it in parallel
It has had several developers work on it at various points
It is important to the business and the business's customers
It is not too slow, nor is it too fast
It is implemented within a Java 2 Enterprise Edition (J2EE) framework
It currently runs on a production system that is underutilized but of limited scale (around 120 cores).

From my work turning this linear process into a parallel one, I have attempted to understand the challenges and opportunities in the world of parallel business computing.

With the business developer in mind, I have attempted to develop a framework that achieves several, limited goals:
Enable parallelism without forcing a re-architecting of existing systems
Be simple enough to code that developers will use it
Be extendable
Achieve practical performance gains without shooting for perfection

### Introduction to Linear Auto Balancing

Auto balancing resolves storage imbalances on a natural gas pipeline. Due to the nature of the industry and its measurement systems, the exact amount of gas flowed on a pipeline is often not exactly known for several months (if ever) after the date of flow. As a result, auto balancing processes six months' of data each night, balancing every shipper with storage.

Each night, the auto balancing code executes a series of large queries to get a complete picture of the pipeline's storage and transportation. With this data, the code then loops through each day, and within each day loops through each shipper, resolving the shippers one-by-one (and day-by-day). Many of the solutions computed do not change from night to night, so only the changes are saved; however, every single solution (called a resolution) is computed due to accuracy concerns (the initial versions of the code had too many moving parts and attempted to be overly smart about ignoring work, leading to errors). All of the results are saved to a temporary location on the database and then committed as a single group to the final tables on the database. The process is coded to view all of the calculations as a single result. Thus, auto balancing, a critical business process, runs nightly on a single core of a single machine in a cluster of top-of-the-line servers with around 120 cores. Clearly, there is room for improvement.

### Ideas Behind Parallel Auto Balancing

My initial thought to turning this linear process into a parallel one was to exploit the structure of the problem (balancing all of the transportation on a gas pipeline), for, I reasoned, if one company's solution primarily depends upon prior solutions to its prior imbalances, and not to the solutions of other companies' imbalances, why must one run all companies together. One can view the dependence of these solutions as a lattice. If every solution depended upon every other solution, the lattice would be dense. If the average solution depends upon only one other solution, then the lattice is sparse. In my model, I essentially have two dimensions: time and resolutions (keep in mind that each resolution is for a single company on a single day). By the definition of the problem, each resolution is dependent upon the prior resolution. Thus, the lattice is completely dense in the temporal dimension. In the resolution dimension, however, there are few connections, and these connections are essentially constant (technically, the can and do change, but they do so once every few years). Thus, the lattice is essentially long strings of resolutions unconnected to other strings. Moreover, where there is a connection, the connection is never more than one layer across. Thus, most strands can be computed completely independently of all other strands. This is excellent because it lends itself to a natural partitioning of the problem (by company). Even when a resolution depends upon another resolution in the same temporal dimension, the problem is no more than four-strings across (4 companies wide). Even this is small enough to be part of a useful partition. Thus, from the outset, the problem had a natural partitioning, which is an important first step to creating a parallel process.

Additionally, I realized that this process, like many business processes, was unbalanced (some results take much longer to compute than others). This unbalanced load makes creating uniform partitions of data difficult. Thus, I quickly abandoned the idea of a uniform partition and instead focused on the master-slave partitioning idea. I could not approach this in a naïve manner, however, because of the vast advantage of caching (a cached database result is an order of magnitude or two faster to retrieve than one that must be retrieved from a remote server or a database). Thus, I decided to use a topology-aware master node and an in-memory cache on each slave node. This decision was especially beneficial because many enterprise-class business systems are scaled up (buy a bigger server) instead of scaled out (buy more servers); for instance, in the production system that this software runs upon, each node has twenty-four cores. If there were a single core per server, then the scheduler would have to ensure that all work for a single company was done on one server. Since, however, there are many cores per server, the scheduler can assign broad amounts of work to the cores on a server and let the workload balance itself (processors working on slower tasks perform fewer units of work).

In a naïve implementation, there would be no simple way to share data between processes efficiently. In a Java 2 Enterprise Edition server, however, one has the ability to create an in-memory cache that can be shared across all cores on the server. On high-core servers, this is hugely advantageous for a process like auto balancing because of the initial queries that must be run to evaluate the imbalances on the system. Such a cache is also important for the scalability of the entire system due to the performance characteristics of a database (it is often much more efficient to return one large result sets instead of many small result sets).

My next thought was to robustness. The production auto balancing process requires low numerical accuracy (to the integer level), but it cannot produce wrong answers at the business-level because the pipeline's customers use the balances it produces to buy and sell gas (conceivably, too, the pipeline could be blown up if the imbalances created a completely false picture of the system that led customers to flow much more gas than they otherwise would). Thus, the process is designed to completely succeed or to completely fail. This behavior is good in that it does not produce incorrect results. This behavior is problematic because when the process fails, a support technician is paged (at 2 AM) to rerun some or all of the process (if the entire process cannot be rerun due to time, the current month's data is recomputed). Depending on the implementation of the parallel framework, it could be made to protect against the failure of a single node. Thus, I extended the master-slave relationship so that work distribution can be changed at run time (instead of compile time).

### Tools Needed to Parallelize Auto Balancing

To implement my ideas, I designed three primary components:
The scheduler
The client executor
The cache

The scheduler and the client executor are the only necessary components, but the cache is so important to the performance, that one should use it (or a home-grown equivalent) if using the other two components.

### The Scheduler

The scheduler is a Java Servlet; thus, it runs within a Java web server framework. This is advantageous because it can be run on light-weight web server (instead of an application server), but, because the Java web framework is a subset of the J2EE framework, it will also run within a J2EE application server (I ran it within such a server in my tests). Thought I designed the scheduler and the client executor to work together, the scheduler is actually independent of the client. The developer must create the objects necessary to describe the work and the system topology to the scheduler (this requires that the developer use the native Java API for the scheduler); once that is done, the scheduler is started programmatically. Once started, the scheduler interacts with the slave nodes via a web interface. The client executor implements the necessary web interfaces to interact with the scheduler, but there is no reason one could not implement the web interface independently of the client executor component. This is useful if one wanted to use the scheduler's power without having to have a Java client. Thus, the scheduler is capable of interfacing with any web-capable language or platform.

The scheduler requires that the slave processes be able to receive their work via an HTTP request. The request includes a developer-coded string that identifies the work units that the slave node will process (the scheduler can be configured to send several units of work at once). The scheduler expects to receive HTTP response code 200 (the HTTP OK message) from the client upon receipt of the message. At that point, the scheduler has no active communication with the slave node.

When the slave node needs more work, it accesses the Servlet via HTTP. Once it has received the request for more work, the scheduler responds with the HTTP OK message. It then looks up the next group of work for the server in question (based upon the request IP address in the HTTP header), and it then goes through the work transmission process again. This asynchronous response-ok model is valuable because it prevents system resources from waiting on remote processes, which could be a long time in responding. Thus, both the scheduler and the client may sit idle while waiting for communication. In a user-facing system, like Rational Pipe is, this is advantageous because the unused resources may be used on user requests, should one come in. Again, J2EE really shines here because it automatically handles the scheduling of requests on a server, so it is possible to give such resources to the user without any code (with a little configuration, one can even assign user threads a higher priority than back-end threads, allowing one to actually run back-end workload in the middle of the day on a front-end server).

### The Client Executor

The client executor is also a Java Servlet. Its only job is to invoke the developer's code in a new thread and to respond with a HTTP OK message back to the scheduler (letting it know that the job has been started). The developer must implement an interface that allows the client executor to pass parameters from the scheduler's HTTP request to the developer's code. The developer's code must be able to interpret the data passed from the scheduler detailing the work; since, however, this identifier comes from the developer's code (that creates the work units), this is reasonable. The client executor is a simple and requires the developer to manage the application context. The real work in getting the application code to execute must be done by the developer. Luckily, such work is often relatively simple once the task of remotely launching the task with the information about the work is started.

### The Cache

The cache is an optional component designed from the need to replace the up-front loading of data done by the linear process. It is a Java-only system through which the user caches data by key-values pairs. The cache allows the developer to specify his own key, though it also provides helper methods that can create a good string-valued key for many common types (calendars, dates, strings, numbers, and mixed-type lists of these data types). The cache resides in the memory of each application server. It is accessed synchronously (i.e., to read the cache, a process must wait for pending writes to complete). Additionally, the cache has the ability to send updates to caches on other nodes. In my testing, I did not utilize this feature since the data was partitioned in a way that did not require such information sharing. I also wrote a wrapper around the cache that allows for a process to do a cache read that blocks until the necessary data becomes available. This mechanism is useful because it compensates for errors in partitioning or in load balancing. Thus, if a process is working on company X's resolution for May 1st, but another process is still working on company X's resolution for April 30th, the May 1st process will wait until the April 30th data is ready. This blocking is bad from a pure performance perspective, but due to the critical nature of the calculations, it is better than producing incorrect results.

### Results

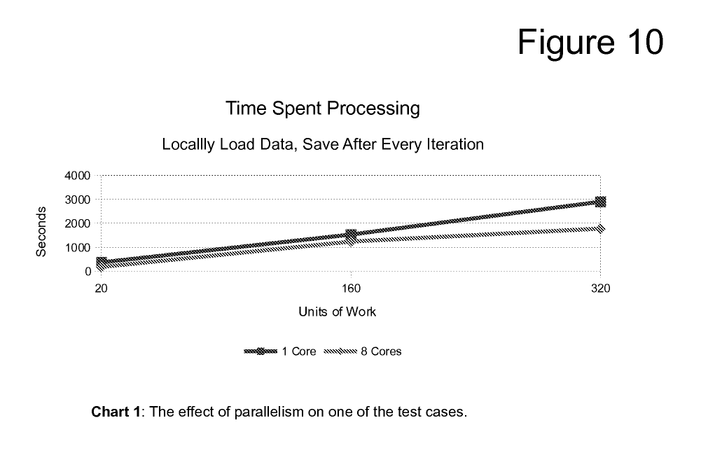

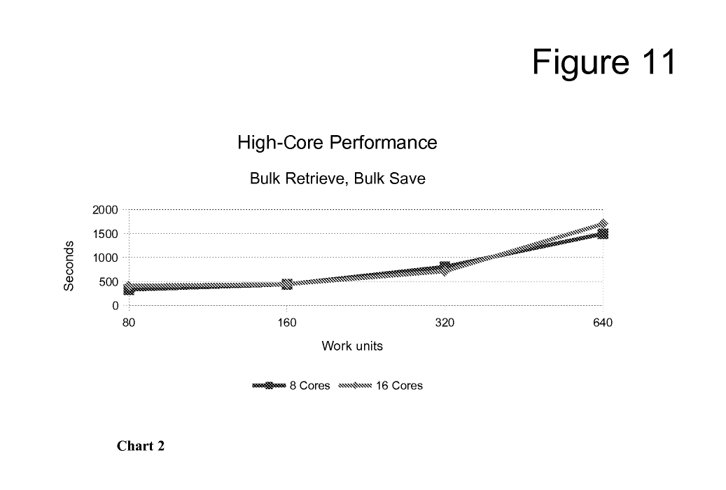

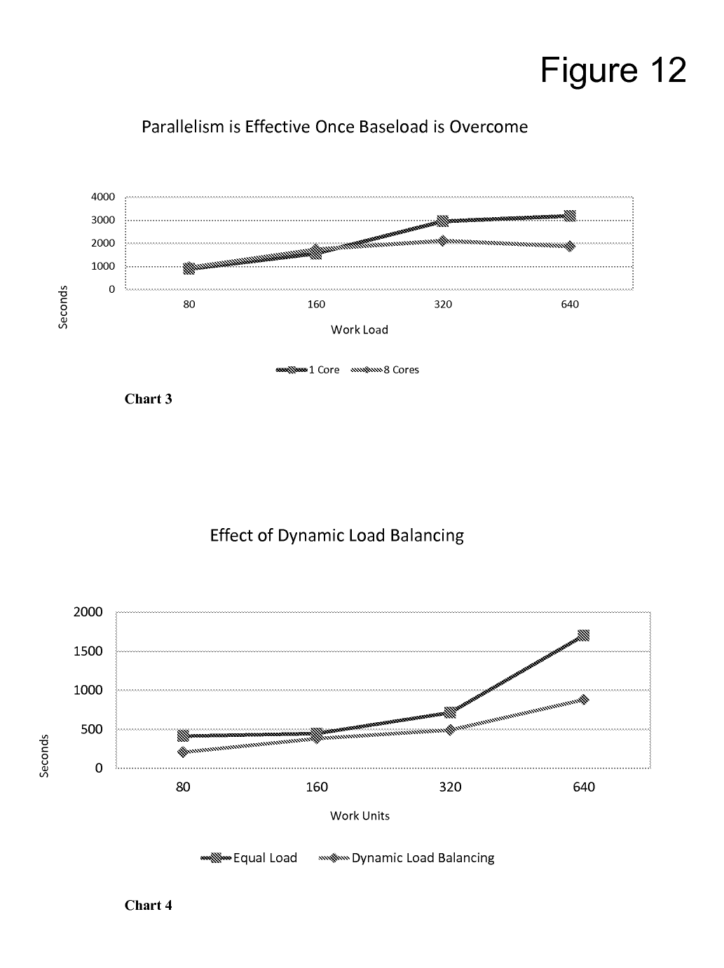

I tested several approaches to the parallel processing of auto balancing. An expected result of the various tests I ran was that the parallel performance of my framework is entirely problem-dependent. It is possible to restructure the problem (once a parallel framework exists) to create various types of performance: improved efficiency (see Chart 1 [SEE FIG. 10]), more robustness without efficiency gains (Chart 2 [SEE FIG. 11]), and good scalability (Chart 3 [SEE FIG. 12]).

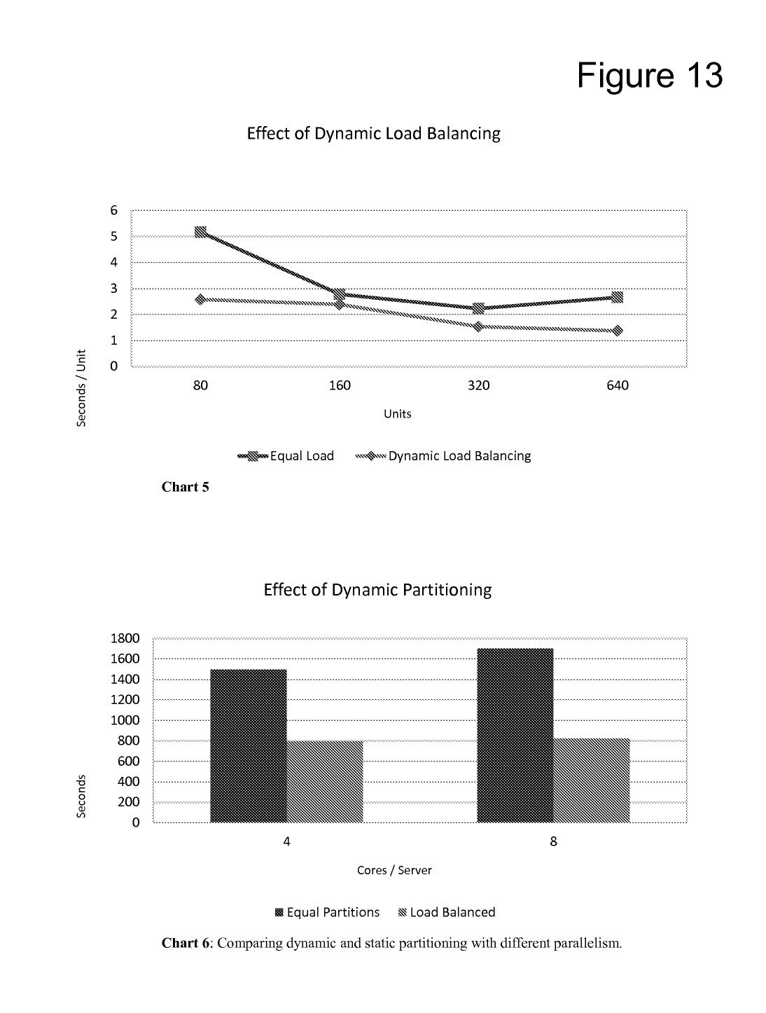

Because my framework allows for using heterogeneous systems, the load balancing is important. My tests showed that remote systems can be effectively incorporated into the processing of large workloads. At one point, I tested the parallel auto balancing with one application server in Houston, residing feet away from the database and sharing the same 100 Mega Bits/second (Mb/s) network, and one application server in Denver, connected over a VPN (with a usable network connection around6 Mb/s). With an equal workload, the Denver server regularly finished later than the Houston server. Changing the workload to use an unequal workload produced a more balanced workload. Charts 4, 5 and 6 [SEE FIGS. 12 AND 13] show the effect of the dynamic partitioning. If a node finishes its own work, it starts taking portions of other servers' workloads. Currently, this is not done in an intelligent manner (i.e., the node takes work from the first non-empty queue it finds). By using dynamic partitioning of the workload, my code achieved a 50% improvement in wall clock time. Moreover, it did so without programmatic or user intervention.

The other major result has been that the tuning of the program to its optimal performance generally requires performing multiple iterations of testing and tuning. This process may even lead to decreasing the scalability of the application. I found this to be the case for auto balancing. I was able to make the test more efficient by caching less data upfront.

### Further Applications

Since one can programmatically interact with the scheduler, one can manipulate, at runtime, the work queues. Thus, the developer may implement a system that handles node failures or workload imbalances. Additionally, the scheduling functionality may be used to create a workload-processing system for unrelated work. Such a system would simply push work in the scheduler's queue as work is needed, and slave nodes would request work as they finish other work. If a node ran out of work, its threads could be used for front-end workload. Such a system would have to automatically wake up the slave nodes at various intervals to ask for more work.

With the idea of pushing the system workload to a cluster (or at least to compute nodes not in the production system), I designed a mechanism for exporting the cache to flat files. This is done by serializing the Java objects within the cache (though the keys are left in String form). I also setup the cache to import these flat files and turn them into a fully-filled cache of Java objects. This allows one to code (or manually design) a process that loads all of the necessary data from a database, cache it, export it to a flat file, push the flat file(s) to a remote system (cluster, cloud, etc), and re-fill the cache from the flat file. At that point, one can use the scheduler to process the work, or, alternatively, independently process the work and reverse the process of shipping the data. One potential application of this mechanism is to create a cluster of slave nodes within a cloud system, each of which is running a Java web server with the Client Interface installed and the developer's code. With such a system, one could provision application servers based upon the workload. The database work would be done at the core system and shipped to the cloud. Because of the scheduling and client mechanisms' use of HTTP, the systems do not need to be within the same data center (they simply need public internet access). The scheduler could handle the job scheduling and the data loading, and the slave nodes need not even know about the database. Moreover, given the cache's ability to push data via HTTP, one could even use the cache directly as the data transmission mechanism and not bother with exporting the data. Doing this creates a fully-distributed, scalable, on-demand system for processing data.

Currently, the scheduler/client system is designed to perform a single set of work until that work is complete. This need not be the case, however. By adding a client-side component to check for new work at regular intervals, the system can easily be used as a real-time workload-processing system. This idea is appealing for many business cases; for example, auto balancing's input is primarily system measurement. Such measurements are read from the electronic meters every 15 minutes, and may be pulled into the system as often as once per hour. Thus, instead of attempting to compute all of the resolutions in one nightly batch, this system could be easily modified to process updates as soon as they come into the system. The code handling the import of the measurement data would notify the scheduler of the additional work, and, when a slave node made its regular work request, the scheduler would pass the work along. This same idea is appealing for billing systems because of the vast amount of work they need to compute. Many business processes are designed to run on a regular basis for large chunks of data, and so the speed of that execution is critical. If instead that workload could be spread throughout the period of time in which data is pulled into the system, the overall time spent computing may go up, but the time the user must wait for the data to become available may go down. Moreover, the time needed to compute the “nightly” run may greatly decrease.

I claim:

1. A method, executed by a scheduler computer system, referred to as a scheduler, of causing tasks of an algorithm to be performed by a plurality of task servers, where the algorithm has a predetermined stopping condition; the method comprises the following:
(a) The scheduler accesses a machine-readable structured representation of a computational task graph;
(b) the nodes of the graph represent the tasks necessary to perform the algorithm;
(c) the edges of the graph represent dependencies between tasks, thereby indicating a preferred order in which tasks are to be executed;
(d) The scheduler computer system allocates a set of one or more work units to each of the plurality of task servers based upon the preferred order indicated in the graph; and
(e) The scheduler computer system sends one or more instructions to each task server to perform the task server's allocated set of one or more work units.

2. The method of claim 1, in which the scheduler computer system functions as one of the plurality of task servers.

3. The method of claim 1, in which the various task servers reside in more than one physical location.

4. The method of claim 1, wherein two or more of the plurality of task servers share a data cache.

5. A program storage device readable by a scheduler computer system (100), containing a machine-readable description of instructions for the scheduler computer system to perform the operations described in claim 1.

6. A program storage device readable by a scheduler computer system (100), containing a machine-readable description of instructions for the scheduler computer system to perform the operations described in claim 4.
